(19) United States
(12) Patent Application Publication
(10) Pub. No.: US 2026/0007492 A1
(43) Pub. Date: Jan. 8, 2026

(54) RESTORATIVE DENTISTRY JAW ARRANGEMENT

(71) Applicant: Teknek Dental Laboratories, LLC, Rockville, MD (US)

(72) Inventor: Gregory Gasper, Rockville, MD (US)

(21) Appl. No.: 18/763,025

(22) Filed: Jul. 3, 2024

(51) Int. Cl. A61C 7/36; A61C 8/00

(52) U.S. Cl. CPC A61C 7/36; A61C 8/0096

(57) ABSTRACT

A device for arranging a fabricated dental apparatus with respect to jaw members of a patient during a restorative dental procedure includes a main body and a stabilizer portion. The main body is configured to support the fabricated dental apparatus and includes either a mandible surface configured to engage a mandible of a patient or a maxillary surface configured to engage a maxilla of a patient. The stabilizer portion includes a maxillary surface or a mandible surface, respectively, and is configured to be removably fitted to a maxilla or mandible of the patient, respectively. Thus, the main body and the stabilizer portion predictably position the fabricated dental apparatus with respect to the mandible and the maxilla to facilitate installation of the dental apparatus onto the mandible and the maxilla in a proper alignment.

### FIELD OF INVENTION

The present application relates to restorative dentistry and, in particular, to techniques for arranging a fabricated dental apparatus with respect to jaw members of a patient during a restorative dental procedure.

### BACKGROUND

In dentistry, the Vertical Dimension of Occlusion (VDO), which is a reference to the measurement of distance between maxillary (upper) and mandibular (lower) jaws, is often an important guide for restorative procedures. On a dental patient who has all natural teeth, VDO is measured while the patient's upper teeth contact the patient's lower teeth and extends from the point where lower teeth enter the gums to the point where the upper teeth enter the gums. However, the VDO in a patient's mouth may not always be desirable from a clinical perspective and is sometimes corrected by a dental professional. In fact, when a patient has no natural teeth, a dental professional will need to establish proper VDO for the patient during clinical procedures, such as during installation of dentures or other restorative dentistry procedures.

Often, dental professionals use laboratory articulators and dental stone models to simulate clinical jaw relations without the patient physically present. The dental stone models are created from dental impressions taken from a patient, e.g., of the maxillary and mandibular jaws and any existing teeth. Laboratory articulators are often physical devices but can also be or include software applications that can manipulate the dental stone models to orient the dental stone models with respect to each other in positions that align with clinically accepted jaw relations. For example, a dental professional may use an articulator (physical or virtual) to determine preferred jaw relations to achieve a clinically acceptable VDO.

The clinically acceptable VDO generally positions both jaws with respect to a jaw midline (e.g., a vertical axis or plane vertically bisecting the jaw), a jaw occlusal plane, and with respect to condylar jaw joints (e.g., the mandibular condyles, which serve as the articulation point for the temporal bone and, together with the temporal bone comprises the temporomandibular joints (TMJ)). These preferred jaw relations are critical for restorative dentistry practices, such as installation of dentures. For example, fabricated jaw devices (e.g., dentures) will, in theory, accurately fit in a patient's mouth with the preferred VDO if fabricated based on the preferred jaw relations established in the articulator.

Unfortunately, transferring dimensions from an articulator to a patient's mouth/jaw is often inexact and can cause misalignment during restorative dental procedures. For example, if bone, tissue, and/or one or more teeth are removed from a patient's mouth (e.g., from the upper ridge area) during dental surgery, clinical VDO will be increased at the site of surgical removal relative to the corresponding points on the lower opposing ridge or tooth area. Then, the clinical and laboratory data will be different. A dental professional can attempt to increase or decrease VDO during this procedure, e.g., with graduated incisal pins, but such attempts often lack the precision needed to ensure fully accurate alignment.

### SUMMARY

The present application relates to techniques for arranging a fabricated dental apparatus with respect to jaw members of a patient during a restorative dental procedure. The techniques may be embodied as at least one or more devices and/or one or more methods. The advantages and features of these techniques are evident in view of the drawings and description included in this application.

According to one implementation, the techniques are embodied as a device for arranging a fabricated dental apparatus with respect to jaw members of a patient during a restorative dental procedure. The device includes a main body and a stabilizer portion. The main body is configured to support the fabricated dental apparatus and includes a mandible surface configured to engage a mandible of a patient. The stabilizer portion includes a maxillary surface configured to be removably fitted to a maxilla of the patient so that the main body and the stabilizer portion predictably position the fabricated dental apparatus with respect to the mandible and the maxilla to facilitate installation of the dental apparatus onto the mandible and the maxilla in a proper alignment.

Additionally or alternatively, the techniques may be embodied as a device with a main body configured to support the fabricated dental apparatus and that includes a maxillary surface configured to engage a maxilla of a patient. In such instances, the device may include a stabilizer portion with a mandible surface configured to be removably fitted to a mandible of the patient, such that the main body and the stabilizer portion predictably position the fabricated dental apparatus with respect to the mandible and the maxilla to facilitate installation of the dental apparatus onto the mandible and the maxilla in a proper alignment.

In either of the aforementioned embodiments, the device positions the maxilla in a predefined orientation with the mandible that ensures proper centric alignment. Additionally or alternatively, the device may position the maxilla a distance from the mandible that ensures clinical vertical dimension of occlusion matches laboratory determined vertical dimension of occlusion and/or position the maxilla a distance from the mandible that ensures functionality of the dental apparatus over a full range of condylar joint movement. Each of these alignments may ensure that the patient is properly treated and will limit discomfort for the patient after a restorative dental procedure, among other advantages. These alignments may also eliminate guesswork for the dental practitioner, reduce the time needed for a procedure (thereby limiting risks for the patient and costs for the practitioner), and potentially reduce the amount of future work needed, e.g., to adjust an initial fitting/alignment of an initial procedure.

Moreover, in either of the above embodiments, the device may arrange the dental apparatus with respect to the maxilla and the mandible so that the dental apparatus is installed into a position on the maxilla or the mandible in a position that matches clinically recorded positions from laboratory examinations. That is, the device can successfully transfer dimensions from an articulator to a patient's mouth/jaw, reducing or eliminating misalignment during a restorative dental procedure. In fact, the device presented herein may accurately transfer dimensions/alignment even if bone, tissue, and/or one or more teeth are removed from a patient's mouth (e.g., from the upper ridge area) during dental surgery. Again, this may eliminate guesswork for the dental practitioner, reduce the time needed for a procedure (thereby limiting risks for the patient and costs for the practitioner), and potentially reduce the amount of future work needed, e.g., to adjust an initial fitting/alignment of an initial procedure.

In some instances, the above-described device(s) include an arch engagement portion. When the main body of the device includes a mandible surface configured to engage a mandible of a patient, the arch engagement portion is configured to engage a maxillary arch of the patient. Alternatively, when the main body of the device includes a maxillary surface configured to engage a maxilla of a patient, the arch engagement portion may be configured to engage a mandibular arch of the patient. In any case, in some of these instances, the arch engagement portion is coupled to the main body via extensions that extend from opposite sides of the arch engagement portion to opposite ends of the main body. In fact, in some embodiments, the stabilizer portion includes a first stabilizer and a second stabilizer, and the extensions extend to the opposite ends of the main body via the first stabilizer and the second stabilizer. These features, in any combination, may ensure that the device securely engages fixed structures within the mouth, such as palatial features, bones, etc.

According to another implementation, the techniques presented herein are directed to a method of arranging a fabricated dental apparatus with respect to jaw members of a patient during a restorative dental procedure. The method includes determining clinical jaw relations of upper and lower jaws of a patient, obtaining dental impressions and orienting the dental impressions in the clinical jaw relations on a laboratory articulator to fabricate a dental apparatus. Then, the fabricated dental apparatus is transferred to a patient mouth in accordance with the clinical jaw relations via a device comprising a main body and a stabilizer portion. The main body of the device is configured to support the fabricated dental apparatus and includes a surface configured to engage one of a maxilla of a patient or a mandible of the patient. The stabilizer portion includes a surface configured to be removably fitted to an other of the maxilla or the mandible, such that the main body and the stabilizer portion predictably position the fabricated dental apparatus with respect to the mandible and the maxilla to facilitate installation of the dental apparatus onto the mandible and the maxilla in an alignment that matches the clinical jaw relations. In some instances, the transferring of the method includes engaging an arch engagement portion of the stabilizer portion with a maxillary arch or a mandibular arch of the patient.

### BRIEF DESCRIPTION OF THE DRAWINGS

To complete the description and to provide for a better understanding of the present invention, a set of drawings is provided. The drawings form an integral part of the description and illustrate an embodiment of the present invention, which should not be interpreted as restricting the scope of the invention, but just as an example of how the invention can be carried out. The drawings comprise the following figures:

FIG. 1A is a schematic drawing of a side view of a skull that illustrates portions and features of a human mouth.

FIG. 1B is a schematic drawing of a front perspective view of a skull that illustrates portions and features of a human mouth.

FIG. 2 is a top perspective views of a first embodiment of the restorative dentistry device of the present application while supporting a restorative dental apparatus.

FIG. 3 is a side perspective views of the restorative dentistry device of the FIG. 2 supporting a restorative dental apparatus while being utilized with pre-surgical models of a patient mouth.

FIG. 4A is a side perspective views of the restorative dentistry device of the FIG. 2 supporting a restorative dental apparatus while being utilized with post-surgical models of a patient mouth.

FIG. 4B and 4C are side perspective views of the restorative dentistry device of FIG. 2 being utilized with pre-surgical and post-surgical models of a patient mouth to demonstrate how the restorative dentistry device of FIG. 2 maintains jaw relations through surgery.

FIG. 4D is a rear, upside-down perspective view of the dental apparatus of FIG. 4A installed on a post-surgical model as an example of how the restorative dental apparatus may be installed in a patient's mouth without the restorative dentistry device presented herein.

FIGS. 5 and 6 are bottom perspective views of a second embodiment of the restorative dentistry device of the present application being utilized with models of a patient mouth.

FIG. 7 is a front perspective view of the restorative dentistry device of FIGS. 5 and 6 being utilized with models of a patient mouth.

FIG. 8 is a side perspective view of the restorative dentistry device of FIGS. 5 and 6 being utilized with models of a patient mouth while supporting a restorative dental apparatus.

FIG. 9 is a flowchart depicting a method of arranging a fabricated dental apparatus with respect to jaw members of a patient during a restorative dental procedure.

Like numerals have been used throughout the Figures.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

Generally, the present application is drawn to techniques for arranging a fabricated dental apparatus with respect to jaw members of a patient during a restorative dental procedure. To accomplish this, the device is configured to engage fixed surfaces of a patient's mouth, which allow the device to accurately transfer dimensions/alignment from an articulator to a patient mouth, even if bone, tissue, and/or one or more teeth are removed from a patient's mouth (e.g., from the upper ridge area) during dental surgery. This may eliminate guesswork for the dental practitioner, reduce the time needed for a procedure (thereby limiting risks for the patient and costs for the practitioner), and potentially reduce the amount of future work needed, e.g., to adjust an initial fitting/alignment of an initial procedure. In some instances, the device positions a maxillary dental apparatus (e.g., an upper denture) with respect to the mandible and maxilla of a patient. Additionally or alternatively, the device positions a mandibular dental apparatus (e.g., a lower denture) with respect to the mandible and maxilla of a patient.

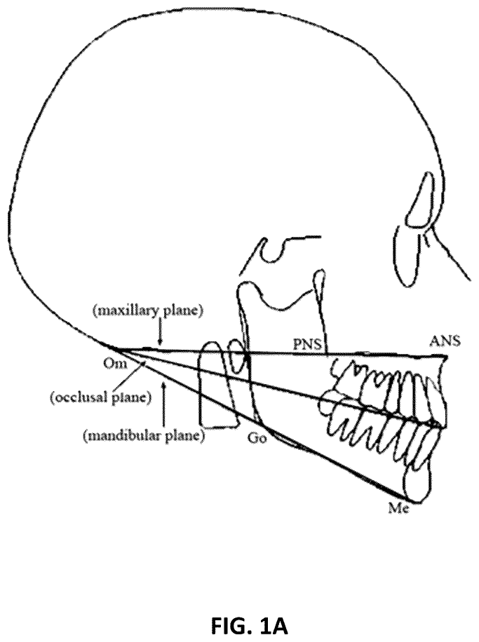

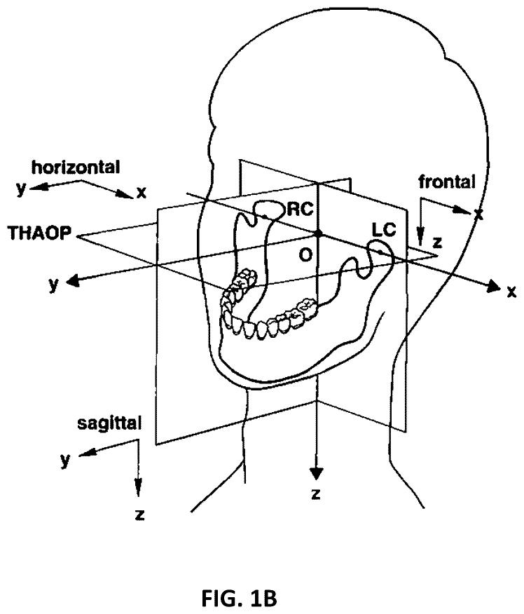

FIG. 1A provides a schematic drawing of a side view of a skull illustrating portions and features of a human mouth/jaw. As can be seen, the human jaw generally extends from a maxillary plane at its top to a mandibular plane at its bottom. The mandibular plane extends along the mandible of a patient's mouth and is generally defined as a plane that intersects a posterior nasal spine (PNS) and an anterior nasal spine (ANS) of a patient. Meanwhile, the maxillary plane extends along the maxilla of a patient's mouth and is generally defined as a plane that intersects the gonion (Go) and the menton (Me) of a patient. Thus, in a healthy mouth with a full set of teeth, upper teeth are generally aligned with and held by the maxilla while lower teeth are generally aligned with and held by the mandible. An occlusal plane extends between the maxillary plane and the mandibular plane and, in a clinically aligned mouth, generally aligns with the occlusal surfaces of the teeth when the jaw is closed.

FIG. 1B provides a schematic drawing of a side view of a skull to further illustrate features of a human mouth. In this depiction, an x-axis extends between the right condyle (RC) and the left condyle (LC) of a skull, each of which may form a portion of a TMJ. Additionally y- and z-axes intersect the x-axis at a centric point (O) that is disposed halfway between the left and right condyles. The x-y plane generally defines a horizontal plane known as the terminal hinge axis-orbital plane (THAOP), while the x-z plane and y-z plane represent frontal and sagittal planes, respectively, with which a clinically aligned jaw is often aligned. While FIGS. 1A and 1B do not depict gums of the mandible or maxilla, a VDO is generally defined between the mandibular plane and the maxillary plane, from the point where lower teeth enter the gums to the point where the upper teeth enter the gums. That is, the distance between the mandibular plane and the maxillary plane defines the maximum VDO for a patient.

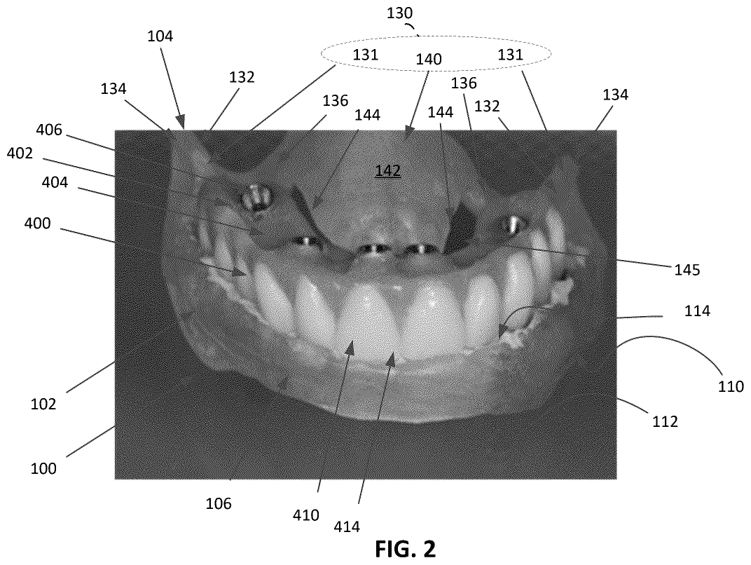

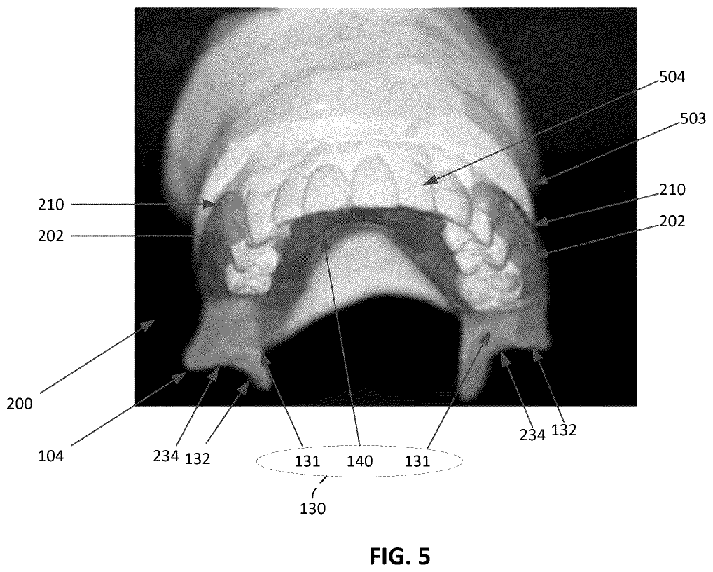

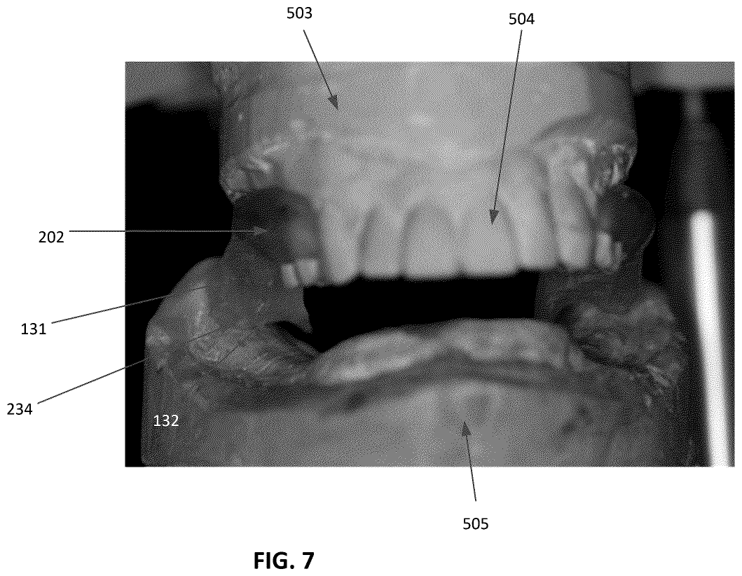

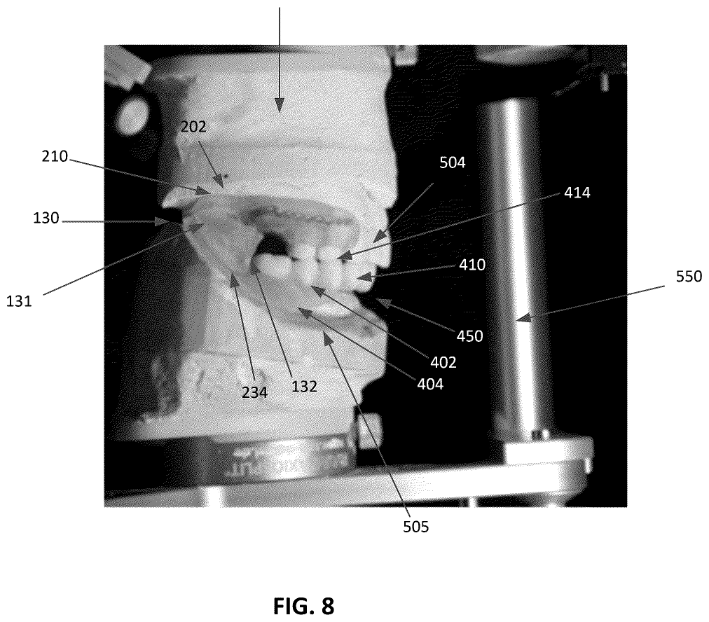

FIG. 2 is a top perspective views of a first embodiment of the restorative dentistry device of the present application while supporting a restorative dental apparatus. In this example, a positioning device 100 is configured to arrange a dental apparatus 400 that may be referred to as a maxillary dental apparatus (e.g., an upper denture) with respect to the mandible and maxilla of a patient. During the restorative procedure, dimensions of a surgical area for the restorative procedure may change and cannot be used as references/guides during installation of the dentures on the patient; instead, the dental professional will rely on the device 100 (without device 100, professionals often use a rough estimate). Thus, the device 100 fully supports the dental apparatus 400 to achieve proper alignment, including clinical VDO, of the dental apparatus 400 with the patient's mouth/jaw. However, in other embodiments (such as the embodiment of FIGS. 5-8), the device 100 need not fully support a dental apparatus 400 and can partially support a dental apparatus 400.

In fact, when used herein, the term “support” does not mean, imply, or otherwise suggest direct contact. Instead, when the device 100 is described as “supporting” the dental apparatus 400, this indicates that the device 100 enables installation of the dental apparatus 400 into a patient's mouth, whether through direct contact and/or by only being disposed in areas where the dental apparatus 400 need not be disposed during an installation operation (e.g., so that the device 100 does not interfere with positioning of the dental apparatus 400).

At a high-level, the device 100 extends from a back end 104 to a front end 106 and includes a main body 102 and a stabilizer portion 130. The front end 106 is generally configured to align with a forward frontal plane of a patient's jaw and the back end 104 is generally configured to align with a rear frontal plane of a patient's jaw. Meanwhile, in the depicted embodiment, the main body 102 is a semi-circular body that is generally disposed beneath a distal surface 414 of teeth 410 of dental apparatus 400. More specifically, the main body 102 extends vertically from a mandible surface 110 that is configured to engage the mandible of a patient to a maxillary support surface 114 configured to support the distal surface 414 of the teeth 410 of the dental apparatus 400. In at least some surfaces, the mandible surface 110 includes an arcuate portion 112 that allows the mandible surface 110 to move into flush and/or secure engagement with a mandible of a patient and/or to fit over existing lower teeth included thereon.

The maxillary support surface 114 can also include any desirable shaping that might facilitate secure, but removable engagement with the dental apparatus 400 (e.g., via the teeth 410 of the dental apparatus 400). That is, at a high-level, the main body 102 may have any desirable shape or size to facilitate engagement with the jaw and to support a dental apparatus 400. In the depicted embodiment, the main body 102 engages the mandible and the teeth 410; however, in other embodiments (such as the embodiment of FIGS. 5-8), the main body 102 can engage other portions of the jaw, such as the maxilla, and/or any other portions of a dental apparatus 400.

Still referring to FIG. 2, the stabilizer portion 130 of the depicted embodiment includes two stabilizers 131 and an arch engagement portion 140. The stabilizers 131 are disposed at a back end of the main body 102, e.g., more proximate to back end 104 than front end 106, but extend contiguously from the main body 102. That is, the stabilizers 131 are formed integrally with a rear end of the main body 102, at both sides of the main body 102. Additionally, the stabilizers 131 extend away from the maxillary support surface 114 (e.g., upwards in FIG. 2). In fact, a distal surface 134 of the stabilizers 131 may be configured to engage a maxilla of a patient's mouth. Thus, when the main body 102 sits on a mandible a patient's mouth, the distal surface 134 of the stabilizers 131 may engage the maxilla to stably support the mandible and maxilla in a fixed relationship with respect to each other. In at least some embodiments, the distal surface 134 of one or both stabilizers 131 includes an arcuate portion 132 that facilitates a secure, removable engagement with maxilla of a patient.

In the depicted embodiment, the arch engagement portion 140 is disposed interiorly of the stabilizers 131 and the main body 102. That is, the arch engagement portion 140 is disposed between stabilizers 131 and generally inside the semi-circular main body 102. The arch engagement portion 140 is also coupled to main body 102 via the stabilizers 131 and, more specifically, via extensions 136 that extend between sides 144 of the arch engagement portion 140 and the stabilizers 131. The extensions 136 only form small connections so that the arch engagement portion 140 and/or the extensions 136 do not interfere with installation of the dental apparatus 400 and/or implant areas for the same. Thus, in the depicted embodiment, the arch engagement portion 140 is separated from the main body 102 by a gap 145. However, other embodiments can avoid interfering with installation of the dental apparatus 400 and/or with implant areas without including a gap 145.

In any case, the arch engagement portion 140 may include a maxillary surface 142 that can engage the maxillary arch of a patient's mouth. This may create a second point of contact with the maxilla jaw and, thus, may ensure that the device 100 stably engages the maxillary jaw. However, the maxillary arch need not always serve as the second point of contact and other jaw structures may be utilized instead of or in combination with the maxillary arch. For example, the device 100 might include an arch engagement portion 140 configured to engage a patient's mandibular arch or another portion of a patient's palate.

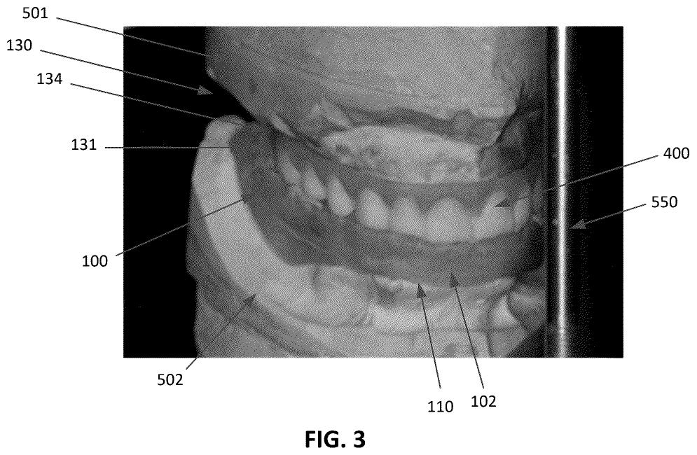

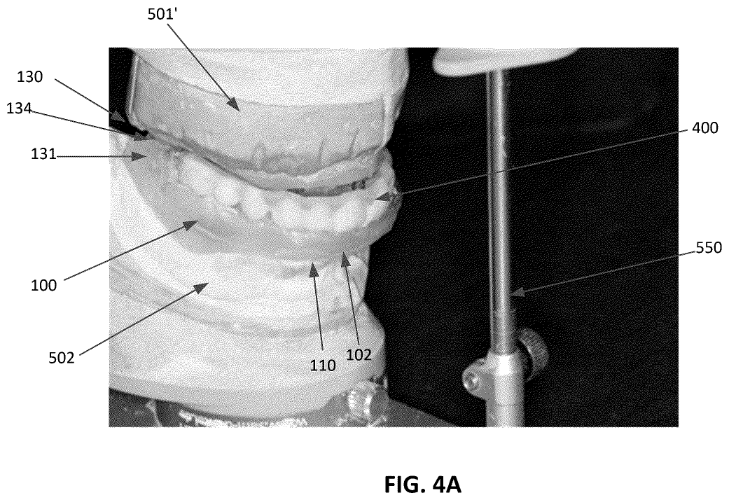

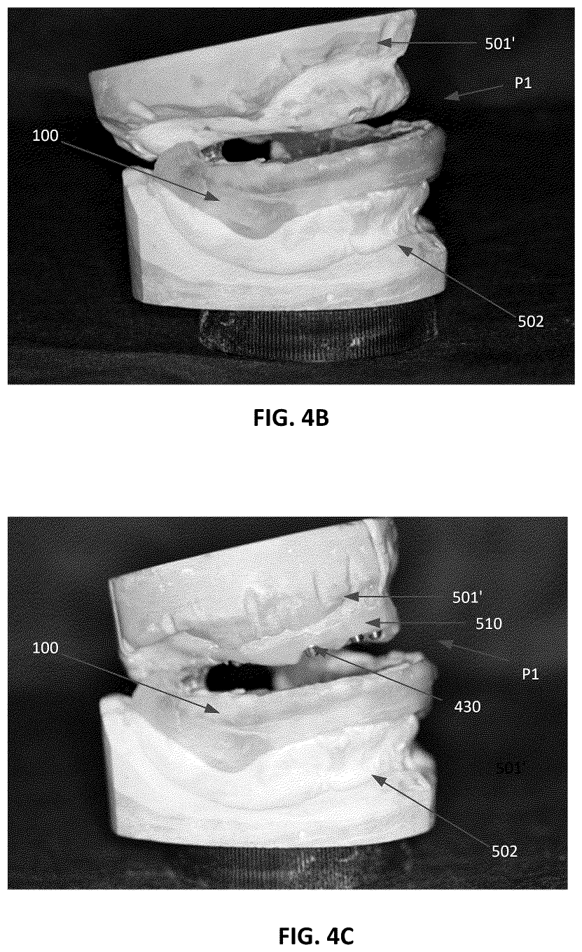

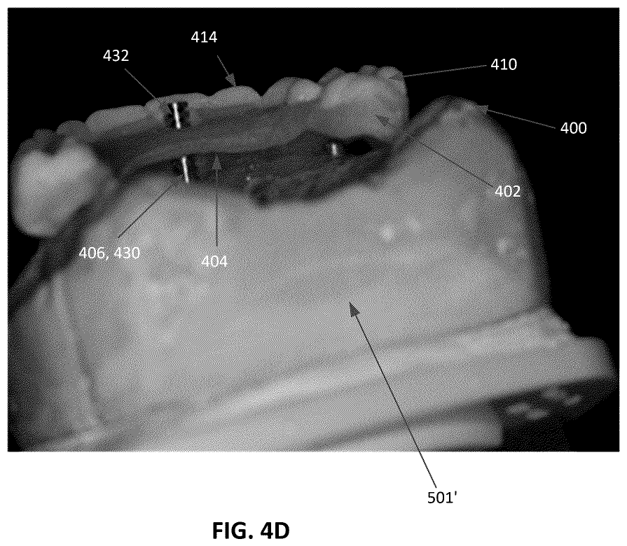

FIGS. 3 and 4A illustrate how the device 100 may position the dental apparatus 400 in a patient's mouth by showing the device 100 and dental apparatus 400 in combination with pre-and post-surgical models. In FIG. 3, the device 100 is shown on pre-surgery maxilla model 501 and a mandible model 502 that are mounted on an articulator 550. Then, FIG. 4A illustrates the device 100 on the mandible model 502 and a post-surgical maxilla model 501′. As can be seen, when a dental apparatus 400 is installed onto a maxilla (as represented by maxilla models 501, 501′) using the device 100, the device 100 engages both the mandible (as represented by mandible model 502) and the maxilla (as represented by maxilla models 501, 501′). More specifically, the mandible surface 110 of the device 100 rests on and engages with the mandible (as represented by mandible model 502) while the distal surface 134 of the stabilizer portion 130 engages with the maxilla (as represented by maxilla models 501, 501′). Additionally, while the arch engagement portion 140 cannot be seen in FIGS. 3 and 4A, the arch engagement portion 140 may also engage the maxilla (as represented by maxilla models 501, 501′) when the dental apparatus 400 and device 100 are positioned as shown in FIGS. 3 and 4A, further securing the device 100 and dental apparatus 400 with respect to the maxilla and mandible.

Here, maxilla models 501, 501′ do not include teeth and the mandible model 502 is missing at least some teeth. However, in other embodiments, one or both of the maxilla and the mandible may include no teeth or some teeth (and the device 100 may be constructed accordingly). Nevertheless, due to the arrangement of teeth in the depicted embodiment, the device 100 fits over existing lower teeth (e.g., due to the shape of the arcuate portion 112 of the mandible surface 110 of the device 100) and fully supports the dental apparatus 400 in the mouth by directly contacting the distal surfaces 414 of teeth 410 of dental apparatus 400.

To achieve these specific engagements, the pre-surgical maxilla model 501 and the mandible model 502 may be cast from impressions taken from a specific patient or formed in any other desirable manner now known or developed hereafter. Then, the device 100 may be designed (e.g., modeled) after manipulating the pre-surgical maxilla model 501 and the mandible model 502 to achieve clinical alignments for that specific patient, such as a recorded clinical VOD. The dental apparatus 400 may also be manufactured using the same model manipulations and alignments. Then, the device 100 can support the dental apparatus 400 as it is transferred from the articulator 550 to the patient's mouth, even after the mouth changes dimensions, e.g., due to surgery preparing the mouth for installation of dental apparatus 400. Post-surgical maxilla model 501′ provides a visualization of how the mouth may look after surgery. This is explained further in connection with FIGS. 4C and 4D below.

Critically, since the device 100 is specifically designed with a main body 102 and stabilizer portion 130 that contact fixed portions of the maxilla and mandible, the device 100 will consistently transfer the dental apparatus 400 from an articulator 550 to a patient's mouth with precise accuracy. Then, the gum 402 of a dental apparatus 400 can be accurately coupled to a patient's jaw by coupling cylinders 406 formed on an installation surface 404 of the gum 402 to corresponding installation pins installed in a patient's jaw. When this coupling is facilitated by the device 100, the coupling will accurately place the dental apparatus 400 with clinically determined VDO, symmetry across the frontal and sagittal planes, etc., even if surgery removes a portion of gum, bone, etc. (e.g., even if a ½ inch of bone and tissue are removed). That is, the device 100 positions the dental apparatus 400 with respect to maxilla and/or the mandible in a predefined orientation that ensures proper centric alignment, that positions the maxilla a distance from the mandible that ensures clinical VDO matches laboratory determined VDO, that positions the maxilla a distance from the mandible that ensures functionality of the dental apparatus over a full range of condylar joint movement, and/or that arranges the dental apparatus with respect to the maxilla and the mandible so that the dental apparatus is installed into a position on the maxilla or the mandible in a position that matches clinically recorded positions from laboratory examinations.

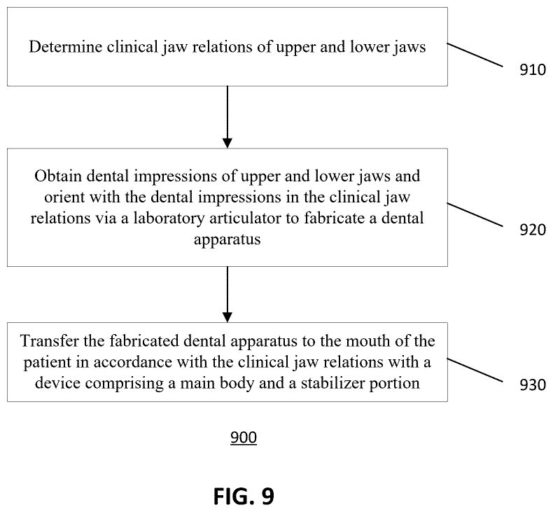

FIGS. 4B and 4C illustrate models that provide a comparison of how a patient's mouth may present prior to and subsequent to surgery preparing the mouth for dental apparatus installation. However, to be clear, with the device 100 presented herein, post-surgical models may not be needed and these models are simply shown for purposes of demonstration. Notably, after surgery, the maxilla model 501′ includes abutments 430 and a surgically repaired area 510, among other disparities. This may be problematic for a dental professional trying to install a dental apparatus built based on the maxilla model 501. However, with the device 100 of the present application, a dental apparatus installed atop of device 100 will be in a proper position P1 before and after surgery. In fact, device 100 can maintain position P1 for a dental apparatus even if a ½ inch of bone and tissue are removed from the maxilla or mandible. FIG. 9 suggests the ill-fitting randomness if positioning a dental restoration made on a pre-surgical on to post surgical with no invented device guidance.

FIG. 4D is a rear perspective view of the restorative dental apparatus 400 of FIG. 2 installed on maxilla model 501 as an example of how the restorative dental apparatus may be installed in a patient's mouth without the restorative dentistry device presented herein (e.g., without device 100). Generally, to install a fabricated dental apparatus, cylinders 406 are coupled to an abutment 430 (i.e., pins) in a patient's jaw to install a fabricated dental apparatus, like maxillary dental apparatus 400, onto a patient's jaw. That is, the abutments 430 are secured to the dental apparatus via cylinders 406 disposed in the dental apparatus 450 and are also secured to implants positioned in a bone (often not visible beneath tissue and the abutment 430). In a model, the abutments 430 are replicated with analog abutments representative of the clinical (i.e., real) abutments. In FIG. 4D, the abutments 430 are secured to the cylinders 406 with abutment units 432. When this connection is complete, the cylinder 406 is considered to be “picked up.” However, if the cylinders 406 is picked up without device 100, it may randomly position the dental apparatus with respect to the jaw. Then, further clinical measurements will be required, which will require additional patient visits. These additional visits and additional measurements can be eliminated with the device presented herein (since it maintains placement accuracy over time, regardless of anatomical changes in a patient).

In FIG. 4D, the dental apparatus 400 was installed without device 100 and, thus, is not properly aligned on the maxilla model 501′, e.g., due to geometry changes in the maxilla model 501′ occurring during surgery. By comparison, when these implant-to-fabricated dental apparatus couplings are made while using the device 100, the cylinders 406 will be fixed in position while the dental apparatus rests on the device 100. This maintains preferred clinical relations as couplings are secured, a process which otherwise tends to move the dental apparatus, even if only slightly. That is, proper use of the device 100 allows accurate, pre-determined, and immediate screw-down transfer of any fabricated dental apparatus on surgically placed abutments. For example, a denture fabricated in a laboratory articulator while precisely positioned to clinically recorded positions and subsequently interfaced with an accurately fitted device 100 can confidently and accurately transfer from the laboratory environment to the patient's mouth.

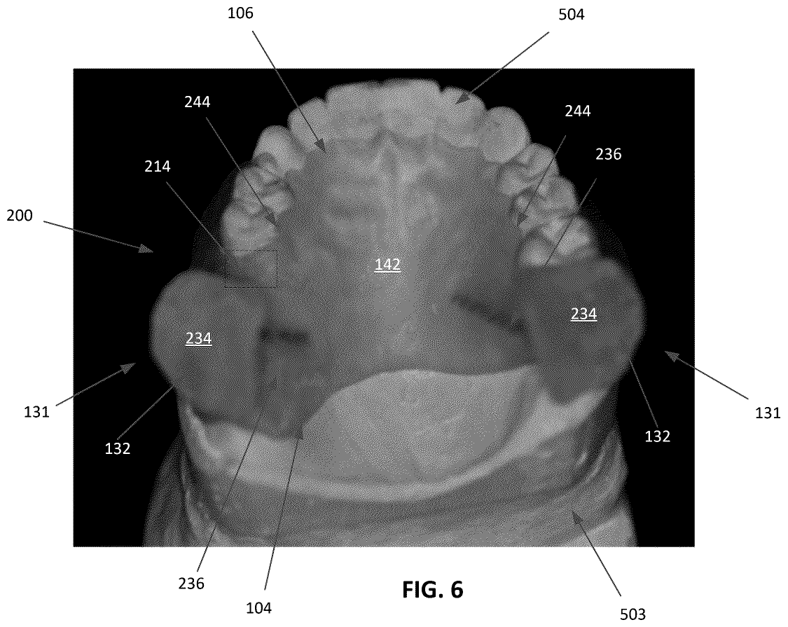

Now turning to FIGS. 5-8, these Figures depict a second embodiment of the restorative dentistry device of the present application. This embodiment includes similar features to the embodiment of FIGS. 2-4 and, thus like numerals are used to label similar parts. Indeed, any description of parts or features included above in connection with FIGS. 2-4 should also be understood to apply to like-labeled parts and features of FIGS. 5 and 6. That said, now, the device 200 is configured to support installation of a mandibular dental apparatus 450 (e.g., lower dentures) in proper alignment, including clinical VDO, and is thus reoriented accordingly. Also, in this particular embodiment, the patient still has some upper teeth and the device 100 must be adjusted accordingly to accommodate these teeth, both to ensure the device 100 and dental apparatus 450 can fit into a mouth and so that the dental apparatus 400 can be properly aligned with the existing teeth.

Most notably, the device 200 includes a main body 202 that extends around the outside of existing upper teeth 504, allowing the existing upper teeth 504 to directly contact the mandibular dental apparatus 450 while still allowing the device 200 to engage the patient's maxilla (as represented by maxilla model 503). That is, the main body 202 at least supports the dental apparatus 450 by allowing the existing upper teeth to extend through device 200 to directly contact the distal surface 414 of the teeth 410 of the mandibular dental apparatus 450. Additionally or alternatively, a portion of the main body 202 may directly support the mandibular dental apparatus 450, e.g., in a location in which a tooth is missing. In the depicted embodiment, mandibular support surface 214 may extend over the area generally denoted with a dashed box to provide support for the mandibular dental apparatus 450 in the area of a missing tooth. This area may also be open and may represent a small area where the mandibular dental apparatus 450 is unsupported. Regardless, because the dental apparatus 450 is a mandibular dental apparatus (as opposed to a maxillary dental apparatus), the main body 202 includes a maxillary surface 210 configured to engage the maxilla (as represented by maxilla model 503). By comparison, the main body 102 of device 100 engages the mandible of the mouth.

Additionally, the stabilizer portion 130 of device 200 includes stabilizers 131 and an arch engagement portion 140 like device 100, but the stabilizers 131 terminate at distal surfaces 234 that are configured to engage a dental apparatus 400 (e.g., via the gum 402) and/or the mandible (as represented by mandible model 505). By comparison, distal surfaces 134 of device 100 engage the maxilla. Still further, while the arch engagement portion 140 includes a maxillary surface 142 configured to engage the patient's maxilla (as represented by maxilla model 503), the arch engagement portion 140 has sides 244 adjacent to existing upper teeth 504 (instead of a gap) and connects to the stabilizers 131 via extensions 236 that are much larger than the extensions 136 of device 100. Despite these differences, distal surfaces 234 and extensions 236 still serve similar purposes to distal surface 134 and extensions 136, respectively. In fact, while a gap is not labeled in FIGS. 5-8, the extensions 236 may bridge a gap between the maxillary surface 142 and the main body 202 of device 200.

FIG. 9 is a flowchart depicting a method 900 of arranging a fabricated dental apparatus with respect to jaw members of a patient during a restorative dental procedure. At step 910, clinical jaw relations of upper and lower jaws of the patient are obtained. For example, a dental professional may manipulate a patient's jaws to achieve clinically acceptable VDO, to position jaws symmetrically with respect to a sagittal plane and/or a jaw occlusal plane, and/or to position jaws properly with respect to condylar jaw joints. Different amounts of manipulation may be necessary in different cases, e.g., since patients may present for treatment showing various occlusion and jaw relations. Patient's may also present without known problems, but dental professionals may still evaluate for improved jaw relations. Regardless, when preferred jaw relations are attained, clinically functional positioning is recorded. At step 920, dental impressions may be obtained and oriented in the clinical jaw relations via a laboratory articulator. These impressions may be obtained in accordance with any dental techniques procedures now know or developed. For example, the impressions may be used to construct physical and/or virtual models that can be physically or virtually manipulated into clinically acceptable arrangements. Then a dental apparatus may be fabricated using the properly oriented dental impressions.

At step 930, the dental apparatus is transferred to the mouth of the patient in accordance with the recorded clinical jaw relations via a device formed in accordance with the present application. That is, the clinical jaw relations are transferred with a device comprising a main body and a stabilizer portion, where the main body is configured to support the fabricated dental apparatus and includes a surface configured to engage one of a maxilla of a patient or a mandible of the patient. Meanwhile, the stabilizer portion includes a surface configured to be removably fitted to an other of the maxilla or the mandible, such that the main body and the stabilizer portion predictably position the fabricated dental apparatus with respect to the mandible and the maxilla to facilitate installation of the dental apparatus onto the mandible and the maxilla in an alignment that matches the clinical jaw relations.

As is detailed above, in some instances, the device intimately fits to the palatal tissue, either alone, or in combination with other selected anatomical features of the human mouth so that the device is stabilized relative to the maxilla and mandible. This secures preferred clinical jaw relations for the dental apparatus installation. However, in some instances, the patient need to bite down (or otherwise have their mouth occluded) to firmly stabilize the device for dental procedures.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. For example, a dental positioning device formed in accordance with the techniques presented herein might position a mandibular dental apparatus and a maxillary dental apparatus, if desired (instead of one or the other). Accordingly, it is appropriate that the appended claims be construed broadly and in a manner consistent with the scope of the disclosure as set forth in the following claims.

It is also to be understood that the dental positioning device described herein, or portions thereof may be fabricated from any suitable material or combination of materials, such as plastic, foamed plastic, wood, cardboard, pressed paper, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Finally, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Similarly, when used herein, the term “comprises” and its derivations (such as “comprising,” etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially.”

1. A device for arranging a fabricated dental apparatus with respect to jaw members of a patient during a restorative dental procedure, the device comprising:
a main body configured to support the fabricated dental apparatus and including a mandible surface configured to engage a mandible of a patient; and
a stabilizer portion including a maxillary surface configured to be removably fitted to a maxilla of the patient, such that the main body and the stabilizer portion predictably position the fabricated dental apparatus with respect to the mandible and the maxilla to facilitate installation of the dental apparatus onto the mandible and the maxilla in a proper alignment.

2. The device of claim 1, wherein the device positions the maxilla in a predefined orientation with the mandible that ensures proper centric alignment.

3. The device of claim 1, wherein the device positions the maxilla a distance from the mandible that ensures clinical vertical dimension of occlusion matches laboratory determined vertical dimension of occlusion.

4. The device of claim 1, wherein the device positions the maxilla a distance from the mandible that ensures functionality of the dental apparatus over a full range of condylar joint movement.

5. The device of claim 1, wherein the device arranges the dental apparatus with respect to the maxilla and the mandible so that the dental apparatus is installed into a position on the maxilla or the mandible in a position that matches clinically recorded positions from laboratory examinations.

6. The device of claim 1, further comprising an arch engagement portion configured to engage a maxillary arch of the patient.

7. The device of claim 6, wherein the arch engagement portion is coupled to the main body via extensions that extend from opposite sides of the arch engagement portion to opposite ends of the main body.

8. The device of claim 7, wherein the stabilizer portion includes a first stabilizer and a second stabilizer, and the extensions extend to the opposite ends of the main body via the first stabilizer and the second stabilizer.

9. The device of claim 1, wherein the stabilizer portion is contiguous with the main body and extends away from a maxillary surface of the main body, the maxillary surface being opposite the mandible surface.

10. The device of claim 1, wherein the mandible surface of the main body comprises an arcuate portion configured to engage arcuate surfaces of the mandible of the patient.

11. A device for arranging a fabricated dental apparatus with respect to jaw members of a patient during a restorative dental procedure, the device comprising:
a main body configured to support the fabricated dental apparatus and including a maxillary surface configured to engage a maxilla of a patient; and
a stabilizer portion including a mandible surface configured to be removably fitted to a mandible of the patient, such that the main body and the stabilizer portion predictably position the fabricated dental apparatus with respect to the mandible and the maxilla to facilitate installation of the dental apparatus onto the mandible and the maxilla in a proper alignment.

12. The device of claim 11, wherein the device positions the mandible in a predefined orientation with the maxilla that ensures proper centric alignment, positions the mandible at a distance from the maxilla that ensures clinical vertical dimension of occlusion matches laboratory determined vertical dimension of occlusion, and/or positions the mandible at a distance from the maxilla that ensures functionality of the dental apparatus over a full range of condylar joint movement.

13. The device of claim 11, wherein device arranges the dental apparatus with respect to the mandible and the maxilla so that the dental apparatus is installed into a position on the mandible or the maxilla in a position that matches clinically recorded positions from laboratory examinations.

14. The device of claim 11, further comprising an arch engagement portion configured to engage a mandibular arch of the patient.

15. The device of claim 14, wherein the arch engagement portion is coupled to the main body via extensions that extend from opposite sides of the arch engagement portion to opposite ends of the main body.

16. The device of claim 15, wherein the stabilizer portion includes a first stabilizer and a second stabilizer, and the extensions extend to the opposite ends of the main body via the first stabilizer and the second stabilizer.

17. The device of claim 11, wherein the stabilizer portion is contiguous with the main body and extends away from a maxillary surface of the main body, the maxillary surface being opposite the mandible surface.

18. The device of claim 11, wherein the mandible surface of the main body comprises an arcuate portion configured to engage arcuate surfaces of the mandible of the patient.

19. A method of arranging a fabricated dental apparatus with respect to jaw members of a patient during a restorative dental procedure, the method comprising:
determining clinical jaw relations of upper and lower jaws of the patient;
obtaining dental impressions of the upper and lower jaws and orienting the dental impressions in the clinical jaw relations via a laboratory articulator to fabricate a dental apparatus; and
transferring the fabricated dental apparatus to the mouth of the mouth in accordance with the clinical jaw relations via a device comprising a main body and a stabilizer portion, the main body being configured to support the fabricated dental apparatus and including a surface configured to engage one of a maxilla of a patient or a mandible of the patient, the stabilizer portion including a surface configured to be removably fitted to an other of the maxilla or the mandible, such that the main body and the stabilizer portion predictably position the fabricated dental apparatus with respect to the mandible and the maxilla to facilitate installation of the dental apparatus onto the mandible and the maxilla in an alignment that matches the clinical jaw relations.

20. The method of claim 19, wherein the transferring comprises:
engaging an arch engagement portion of the stabilizer portion with a maxillary arch or a mandibular arch of the patient.
